(19) United States
(12) Patent Application Publication
(10) Pub. No.: US 2015/0278840 A1
(43) Pub. Date: Oct. 1, 2015

(54) SYSTEMS AND METHODS FOR IMPLEMENTING GROUP INCENTIVES

(71) Applicant: EBAY INC., San Jose, CA (US)

(72) Inventors: Lucy Ma Zhao, Austin, TX (US); Kamal Zamer, Austin, TX (US)

(21) Appl. No.: 14/225,132

(22) Filed: Mar. 25, 2014

(51) Int. Cl. G06Q 30/02

(52) U.S. Cl. CPC G06Q 30/0207

(57) ABSTRACT

A system or method is provided to generate and display incentives or promotions for a group. In particular, the incentives or promotions may be generated based on the combined preferences of the individuals in the group. Further, activities or transactions participated together as a group may be used to infer incentives or promotions for the group. Individuals may be identified or detected as a group based on social networks or contact lists. Further, the group may be identified or detected by detecting the proximity of each other's mobile devices via Near Field Communication (NFC), such as Bluetooth Low Energy (BLE). A shopping display may be installed at a shopping venue to provide directions and/or suggestions to consumers. The shopping display may detect that a group of associated consumers are viewing the shopping display and may generate and display promotions or incentives tailored to the group.

### BACKGROUND

1. Field of the Invention

The present invention generally relates to systems and methods for implementing group incentives.

2. Related Art

Incentives or promotions are often generated to target individual consumers. Nevertheless, consumers often shop or dine with others, such as friends or family. As such, the incentives or promotions generated for individual consumers may not be suitable for consumers who shop in groups. Further, a consumer may shop or dine with different groups of people at different times or places. Thus, it is difficult to generate incentives or promotions that are suitable for these ever changing shopping groups. Thus, there is a need for a system or method that implements incentives or promotions for various shopping groups.

### BRIEF DESCRIPTION OF THE FIGURES

FIG. 1 is a block diagram of a networked system suitable for implementing group incentives according to an embodiment.

FIG. 2 is a flowchart showing a process for generating group preferences according to one embodiment.

FIG. 3 is a flowchart showing a process for generating and displaying group incentives according to one embodiment.

FIG. 4 is a block diagram of a computer system suitable for implementing one or more components in FIG. 1 according to one embodiment.

FIG. 5 is a diagram depicting a shopping display according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system or method is provided to generate and display incentives or promotions for a group. In particular, the incentives or promotions may be generated based on the combined preferences of the individuals in the group. Further, activities or transactions participated together as a group may be used to infer incentives or promotions for the group.

In an embodiment, individuals may be identified or detected as a group based on social networks or contact lists. Further, the group may be identified or detected by detecting the proximity of each other's mobile devices. In an embodiment, Near Field Communication (NFC), such as Bluetooth Low Energy (BLE), may be used to detect the proximity of the mobile devices. For example, when a group of individuals are associated in a social network and are moving or are in proximity to each other in a shopping venue, the individuals may be designated as a shopping group.

In an embodiment, a shopping display may be installed at a shopping venue to provide directions and/or suggestions to consumers. In particular, the shopping display may be a touch screen display configured to receive input from consumers. The shopping display may include a NFC device, such as a BLE beacon, configured to detect and communicate with mobile devices of consumers who are viewing the shopping display. In particular, the shopping display may detect that a group of associated consumers are viewing the shopping display and may generate and display promotions or incentives tailored to the group. The group incentives or promotions may be generated based on the combined preferences of the individuals in the group and/or based on group dynamics or context, such as time or location.

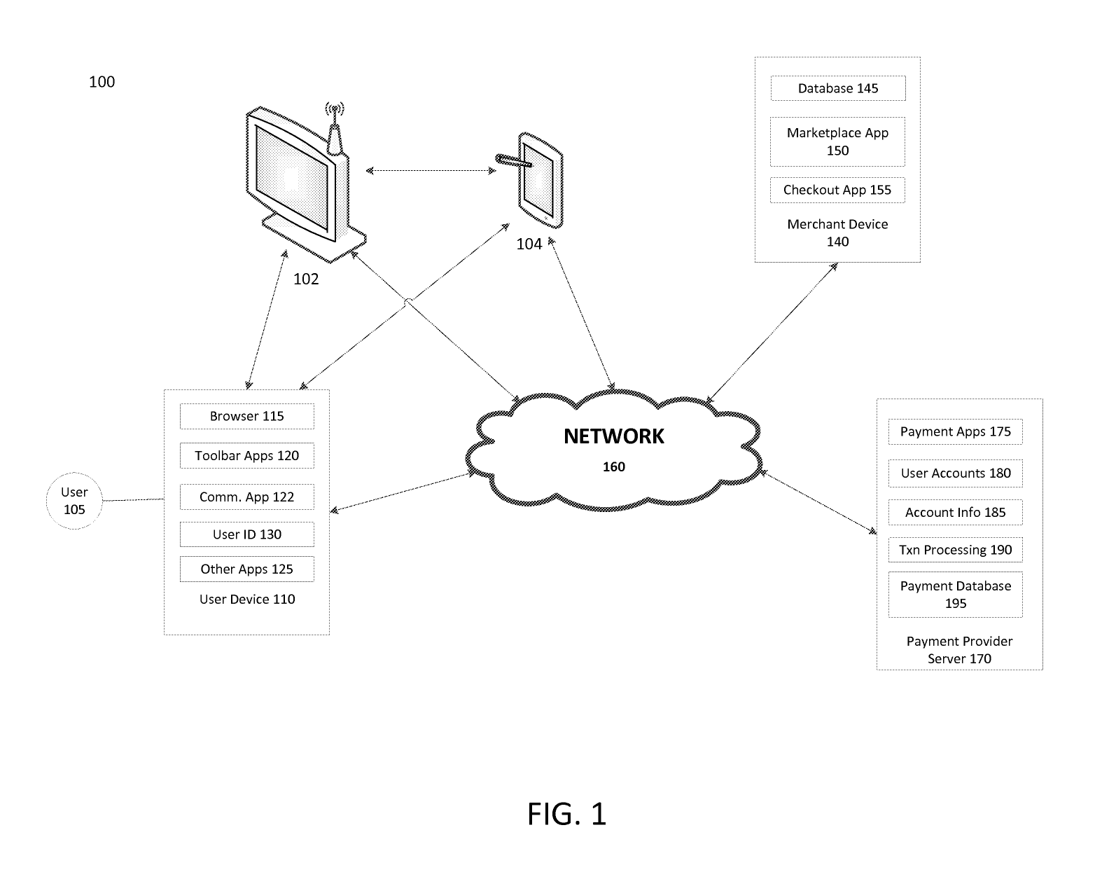

FIG. 1 is a block diagram of a networked system 100 suitable for implementing a process for implementing customer movement tracking analysis according to an embodiment. Networked system 100 may comprise or implement a plurality of servers and/or software components that operate to perforin various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, a payment provider server 170, a communication device 104, and a shopping display 102 in communication over a network 160. Payment provider server 170 may be maintained by a payment service provider, such as PayPal, Inc. of San Jose, Calif. A user 105, such as a sender or consumer, utilizes user device 110 to perform a transaction using payment provider server 170. User 105 may utilize user device 110 to initiate a payment transaction, receive a transaction approval request, or reply to the request. Note that transaction, as used herein, refers to any suitable action performed using the user device, including payments, transfer of information, display of information, etc. For example, user 105 may utilize user device 110 to initiate a deposit into a savings account. Although only one merchant server is shown, a plurality of merchant servers may be utilized if the user is purchasing products or services from multiple merchants.

In some embodiments, user device 110 may download a shopping application from payment provider server 170 or from merchant server 140. The shopping application may allow user 105 to purchase and/or pay for various products or services from a merchant. The shopping display 102 may be installed at various shopping venues of public places to provide information to consumers. In an embodiment, the shopping display 102 may include a BLE beacon configured to communicate with mobile devices of consumers standing in front of the shopping display 102. For example, user device 110 may include a Bluetooth device configured to implement BLE communication. When user 104 is viewing information on the shopping display 102, user device 110 may communicate with shopping display 102 via BLE communication.

User device 110, merchant server 140, payment provider server 170, shopping display 102, and communication device 104 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, laptop computer, a wearable computing device, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 may include a Bluetooth device configured to implement low energy Bluetooth (BLE) communication. For example, user device 110 may communicate with other mobile devices, such as communication device 104, via BLE communication. User device 110 also may communicate with the shopping display 102 via BLE communication. Communication device 104 may be a mobile device operated by another consumer, such as user 105's friend or family. Communication device 104 may include some or more of similar components as that of user device 110.

Shopping display 102 may be a screen installed at public places or shopping venues. Shopping display 102 may be connected to network 160 and may provide information or directions to consumers. Shopping display 102 may include a touch screen to receive a consumer's input. As such, a consumer may input various instructions or queries at shopping display 102 to obtain desired information. The touch screen may be configured to receive multiple inputs from multiple consumers simultaneously.

Shopping display 102 may be configured to communicate via Near Field Communication (NFC), such as BLE communication. In particular, shopping device 102 may include a BLE beacon configured to detect and communicate with mobile devices positioned near shopping device 102. For example, when user 105 is standing in front of shopping display 102, user 105's user device 110 may communicate with shopping display 102 via BLE communication. Further, shopping display 102 may communicate with multiple mobile devices of multiple consumers simultaneously. As such, a group of consumers may use shopping display 102 at the same time to obtain group related information.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes service providers as well as banks and retailers. Merchant server 140 may include a database 145 identifying available products (including digital goods) and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

In some embodiments, payment provider server 170 may maintain a database including transaction history, purchase history, shopping history, location/movement history, browsing history associated with each user. In particular, the database may maintain group related activities, such as shopping trips taken by a user and friends or user dining at a restaurant with family members. Thus, group activities of each user may be saved and referenced later to generate group related incentives or promotions.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

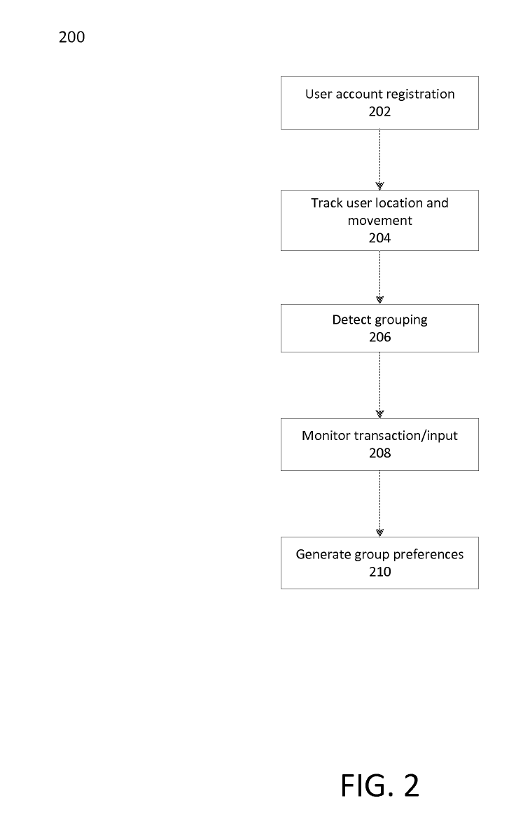

FIG. 2 is a flowchart showing a process 200 for generating group preferences according to one embodiment. At step 202, user 105 may register or set up a payment or purchase account at payment provider server 170 or at merchant device 140. In particular, user 105 may use user device 110 to install a payment/shopping app from payment provider server 170 or merchant device 140. As such, user 105's user device 110 is linked or associated with user 105's account.

At step 204, user 105's location and movement may be tracked or monitored by Global Positioning System (GPS) or other means, such as BLE beacons. For example, a network of BLE beacons may be installed in a shopping venue or a public place to form a grid. The network of BLE beacons may be used to track location and movement of consumers in the shopping venue or public place. In an embodiment, user 105 may indicate the location of user 105 by checking into different places, such as stores or restaurants, via user 105's social network account, mobile app (such as through BLE beacon), or the like.

At step 206, user device 110 may detect other devices in proximity to user device 110 to determine grouping. In particular, user device 110 may detect NFC signals, such as BLE signals emitted from other devices located near user device 110 to determine the presence of other devices in proximity to user device 110. In an embodiment, user 105's social network or contact list may be utilized to determine whether the users of the devices located in proximity to user device 110 are associated or related to user 105. If the devices in proximity to user device 110 belong to people associated or related to user 105, the probability is greater that user 105 is in a group with these people.

In another embodiment, the system, such as through BLE beacons, may track or monitor location and movement of the group to determine grouping. For example, when other devices remain in proximity to user 105 for longer than a predetermined amount of time, the probability is greater that user 105 is in a group with the owners of these other devices. In another example, when other devices move with user 105 continuously longer than a predetermined amount of time, the probability is greater that user 105 is in a group with the owners of these other devices. In still another example, if the other devices are making similar transactions or activities at the same merchants, the probability is greater that user 105 is in a group with the owners of these other devices.

The system may also determine that other users in proximity to user 105 are known to the user, such as through a user's contact list, social network, etc, which would infer user 105 is shopping with a group that includes the other detected users. A type of group may also be determined based on the relationship type of the group. For example, the group is from work if the individuals in the group are related to the user from work or the group is from family or friends if the individuals in the group are related to the user via family or friends. As such, different types of incentives may be generated based on the group type. If the user is with a group from work, incentives related to family or friends may not be presented to protect the user's privacy. Similarly, if the user is with family, incentives related to work may not be presented.

In an embodiment, the system may ask user 105 whether user 105 is shopping or dining in a group and who the other consumers in the group are. Thus, grouping may be determined based on user 105's response. Accordingly, grouping may be detected or determined based on a plurality of factors including location/movement of user 105 and other consumers near user 105, transactions/activities taken by user 105 and other consumers near user 105, social network and contact list of user 105, and/or user 105's input.

At step 208, the system may monitor user 105 and other group member's transactions or activities. For example, user 105 and other group member's purchases of products or services made when shopping as a group may be monitored and stored as a group activity. Other group activities such as dining at restaurants, events attended, places visited, and the like also may be monitored and stored as group activities.

At step 210, the system may generate group preferences including preferred type of products, preferred type of services, preferred merchants, preferred shopping venues, preferred location or time for certain activities, and the like. The group preferences may be generated based on shared group activities or transaction history. For example, if the group frequently dines together at a certain restaurant, the restaurant or other similar restaurants may be a preferred restaurant for the group.

In an embodiment, the group preferences may be generated based on the combined preferences from each individual in the group. Each individual's purchase/transaction history, browsing history, calendar/schedule, location/movement history, music/video streaming history and the like may be combined and compared with each other to infer or generate group preferences. For example, if each individual separately shops at a certain shopping venue, the shopping venue may be preferred shopping venue for the group. In another example, if each individual purchased a certain type of clothing, the type of clothing may be a preferred style of clothing for the group even if each individual purchased the clothing at a different time or place.

Accordingly, process 200 may be implemented to detect, track, and monitor consumers' activities, transactions, locations and movements both individually and as a group. In particular, grouping may be detected based on their social network or contact list and the relative proximity among various consumers. As such, group activities may be identified and monitored to generate group preferences. Group preferences also may be generated by comparing and combining preferences of each individual in the group.

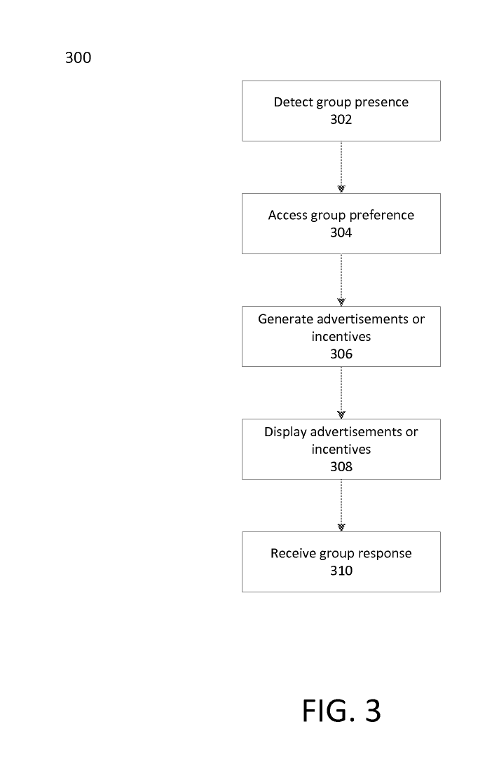

FIG. 3 is a flowchart showing a process 300 for generating and displaying group incentives according to one embodiment. In particular, the group incentives may be generated in real-time by merchant device 140 or payment provider server 170 and sent to shopping display 102 or user device 110 to be displayed. Shopping display 102 may be installed at public places or shopping venues where consumers may view and interact with shopping display 102. Shopping display 102 may include a touch screen to display information to consumers and to receive consumer inputs.

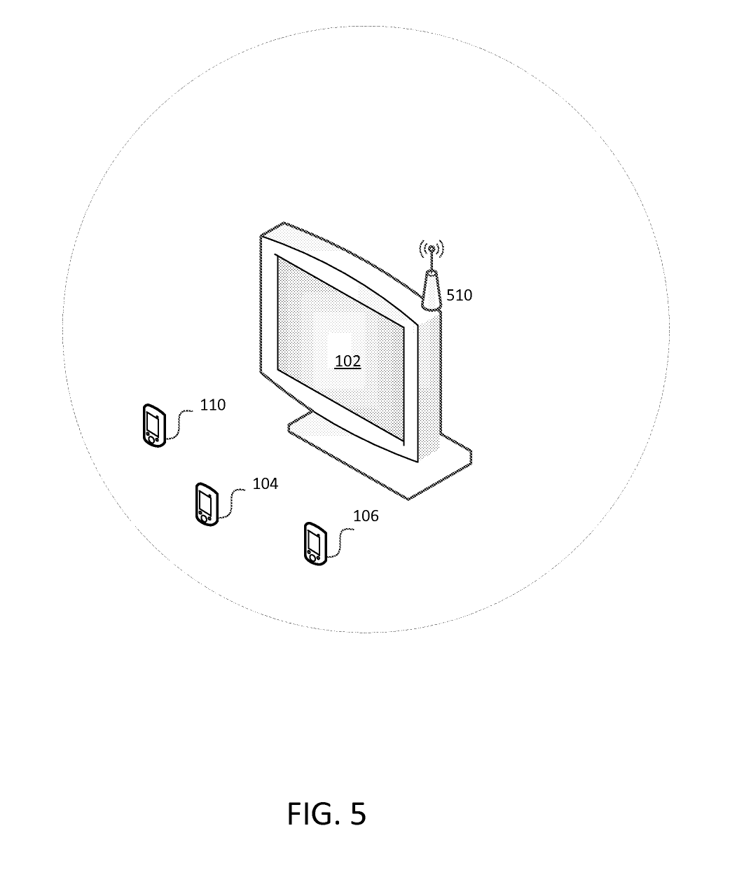

At step 302, shopping display 102 may detect group presence. Shopping display 102 may include a NFC beacon, such as a BLE beacon, configured to communicate with other devices located in proximity to shopping display 102. As shown in FIG. 5, shopping display 102 may include a BLE beacon 510 with a certain broadcast range, as shown in a dashed-line circle. BLE beacon 510 may detect consumers' presence by detecting their mobile devices, such as mobile devices 104, 106, and 110, when the mobile devices enter into the broadcast range of BLE beacon 510. The broadcast range of BLE beacon 510 may be limited to a distance based on a viewing range of the shopping display 102. Thus, mobile devices of consumers who can view the shopping display 102 are connected while mobile device of consumers who are too far from the shopping display 102 to view the shopping display 102 are excluded.

In some embodiments, shopping display 102 may include a camera or a microphone that may capture images or voices of the consumer standing in front of shopping display 102. Facial or voice recognition techniques may be used to identify the consumers. In an embodiment, the interactions among the consumers may be captured to determine whether they are a group. For example, if the consumers are standing close to each other or are talking to each other, the probability that they belong in the same group is greater.

After detecting the presence of consumers, mobile devices 110, 104, and 106 may begin to communicate with shopping display 102 via NFC, such as BLE communication. In particular, mobile devices may each send user information to shopping display 102 via NFC. The user information may include user's account information at the merchant or at the payment service provider. User's account information may include various user preferences and group preferences as obtained or determined in process 200. In particular, group preferences of each consumer also may be communicated to shopping display 102. In some embodiment, after the consumers are identified, shopping display 102 may request the consumers' user preferences and/or group preferences from merchant device 140 or payment provider server 170.

In an embodiment, grouping may be determined based on group preferences of each consumer standing in front of the shopping display 102. For example, if the group preference information of the user of device 110 includes the user of device 104 in a shopping group, then the user of device 110 and the user of device 104 may be determined to be in a group. In an embodiment, grouping also may be determined based on social network or contact lists of each consumers.

At step 304, the system may access the group preferences of the consumers in the group. In particular, group preferences that are generated based on group activities shared by some or more of the consumers standing in front of the shopping display 102 may be retrieved. For example, assuming that users of device 110 and 104 are determined to be in a group, the group preferences based on the dining or shopping activities experienced together by these two users may be retrieved. In another example, future events may be retrieved for group members based on individual calendars for members of the group, e.g., attending the same concert, dinner, play, or other event in the near future, which may trigger some suggestions or incentives for purchases.

At step 306, the system may generate advertisements or incentives for the group or an individual in the group based on the shared group preference of the consumers standing in front of the shopping display 102. In particular, incentives or advertisements may be generated based on preferred merchants shared by the group, preferred styles or types of products or services shared by the group, location/venues shared by the group. For example, if the group has shopped together frequently at a certain apparel store, coupons or discounts tailored to the group may be generated to entice the group to visit and make purchases at the apparel store.

In another example, merchants or stores similar to the apparel store may be identified and be introduced to the group. Incentives or advertisements may be generated based on group dynamics and environmental context. For example, on a hot summer day, an ice cream shop may be suggested to the group. When lunch time is approaching, a coupon or discount may be generated for a restaurant preferred by the group or similar restaurants to entice the group to dine at the restaurant. In another example, the coupons or discounts may be generated based on the number of people in the group, such as a buy-3-get-1 free coupon for a 4 person group.

In an embodiment, the advertisements or incentives may be generated by combining or comparing separate user preferences of each individual in the group. For example, the system may determine that each of the users in the group has shopped at a certain store separately based on each user's individual user preference. The system may combine and compare their separate shopping history and may generate incentives for the group to entice the group to visit and shop at this store together. In another example, the system may determine that each of the users in the group had purchased a ticket to the same cruise vacation based on their separate purchase histories, the system may generate a coupon or advertisement for a swimsuit store to entice them to shop at the swimsuit store together in preparation for the cruise vacation.

In some embodiments, when multiple consumers are standing in front of the shopping display 102 but the consumers are not related as a group, the system may generated more generic incentives or advertisements, such that individual preferences of these un-related consumers are not revealed to each other to protect each consumer's privacy. Thus, when only one consumer is viewing the shopping display 102, more individualized incentives or advertisements may be generated for this one consumer.

At step 308, the generated advertisements or incentives may be displayed to the consumers at the shopping display 102. In particular, the graphical size and position of the advertisements or incentives may be adjusted based on the position of the consumers. For example, the display size of an incentive may be increased for a larger group while the display size of an incentive may be decreased for an individual consumer. Further, the display position of the incentive is adjusted such that the incentive is directly in front of the intended viewer or a group of intended viewers.

The shopping display 102 may be a large wall of touch screens installed at a shopping venue. As such, multiple consumers and/or multiple groups of consumers may view and operate various portions of the shopping display 102 at the same time. One or more cameras may be provided at the shopping display 102 to detect the position and viewing angles of various consumers. As such, appropriate size and positions of incentives may be used to display them to the appropriate consumers standing at different positions in front of the shopping display 102.

In one embodiment, incentives or promotions may be an image or a video including audio outputs. As such, multiple speakers may be provided at various portions of the shopping display 102 to output various audio promotions/incentives to consumers standing at various positions. For example, a group of consumers may be viewing a video promotion on a left side of the shopping display 102 while an individual consumer may be viewing a shopping coupon on a right side of the shopping display 102. As such, the speakers on the left side of the shopping display 102 may output the sound for the video while the speakers on the right side of the shopping display 102 may be silent. In another embodiment, incentives may be provided to individual consumer devices, such as one or more smart phones of consumers in the group. Note that the incentive may be provided to all members of the group or selected member(s) of the group, and the incentive may be different or the same for different members of the group.

At step 310, shopping display 102 may receive inputs from consumers in response to the group promotions or incentives. For example, consumers may accept the incentives or promotions and a digital coupon or discount may be communicated to the consumers' mobile devices from shopping display 102, merchant device 140, or payment provider server 170. In another example, shopping display 102 may display products and consumers may purchase the displayed products at shopping display 102. In still another example, the group consumers may accept an invitation to attend an event, a service, or a restaurant and the system may check the availability of the event, service or restaurant based on the number of people in the group. The events may include movies, shows, concerts, presentations, and the like. The service may include group orientated service, such as games, spas, salons, and the like. The system may display available time and location for the event, service, or restaurant and allow the group of consumers to make reservations or appointments for the group at the event, service, or restaurant.

By using the above process 300, appropriate incentives or advertisements may be generated for a group or an individual, such as on a user device and/or at the shopping display 102. In particular, group incentives or advertisements may be generated based on combined individual preferences and group preferences. Group incentives also may be generated based on context, such as recent purchases by the group, weather, location, time, and the like. In addition, the incentives or advertisements may be formatted appropriately and displayed to the group on the shopping display 102. Additional user inputs may be received at the shopping display 102 to accept the incentives and/or to make appointments or reservations to use the incentives.

The above processes 200 and 300 may be executed by shopping display 102. In another embodiment, the above processes 200 and 300 may be executed by payment provider server 170 or merchant device 140. In still another embodiment, the above processes 200 and 300 may be executed by one or more of user device 110, communication device 104, shopping display 102, merchant device 140, and payment provider server 170 in coordination with each other.

The following are exemplary scenarios in which the above processes 200 and 300 may be implemented.

### Example 1

Amy, Ben, and Carl are good friends who like to hang out together during their spare time. Each of them carries a mobile device installed with a shopping app from a payment service provider, such as PayPal, to facilitate shopping and payments. The shopping app monitors and keeps track of each of their individual activities and/or transactions. Further, the shopping app detects group activities experienced by them as a group, such as when they go shopping together in a shopping mall or when they dine together in a restaurant. As such, group preferences are generated based on their group activities.

This Saturday afternoon, Amy, Ben, and Carl are hanging out again at a shopping mall. A shopping display, e.g., a shoppable glass, is installed at the entrance of the shopping mall to provide information to shoppers. When Amy, Ben, and Carl approach the shopping display, the shopping display detects each of their mobile devices and identifies them as a group based on their respective identities and their group preferences. The shopping display then begins to generate incentives or promotions based on their combined individual preferences and their group preferences.

In particular, the system determines that they like to shop at young apparel stores together and that there is a new store offering young apparel recently just opened in the shopping mall. Thus, a buy-2-get-1-free coupon at the new store is generated for the group to entice the three people group to visit and make purchase at the new store. Information regarding the new store also is displayed to the group, such as the direction to the store, pictures of the store, sample pictures of various apparels offered at the store, or a video about the store. The group decides to accept the coupon and to visit the new store. A digital coupon is communicated to each of their mobile devices. As such, the coupon is automatically applied to their purchases made at the new store when they pay for their purchase using their mobile devices.

### Example 2

Sammy walks up to a shopping display at an outlet mall with her group of friends. The shopping display receives Sammy's user information from Sammy's mobile device. The shopping display also recognizes that Sammy is with a group of friends by detecting the friends' mobile devices. As such, the shopping display generates content and offers based on the fact that they are in a group and that the group just booked a cruise together. The shopping display shows information and items, such as bikinis and other cruise attire. Further, the shopping display also shows stores in the outlet mall that offer products or services related to vacation and cruise. Sammy and her friends have a good time shopping together.

Sammy and her friends are back at the shopping display around dinner time, the shopping display generates an offer to book them a table for dinner at a restaurant near the outlet mall. The shopping display determines the number of people in the group and books a table based on the number of people. Sammy and her friends accept the offer to make the reservation at the restaurant. The shopping display then sends the reservation request and their payment preference to the restaurant.

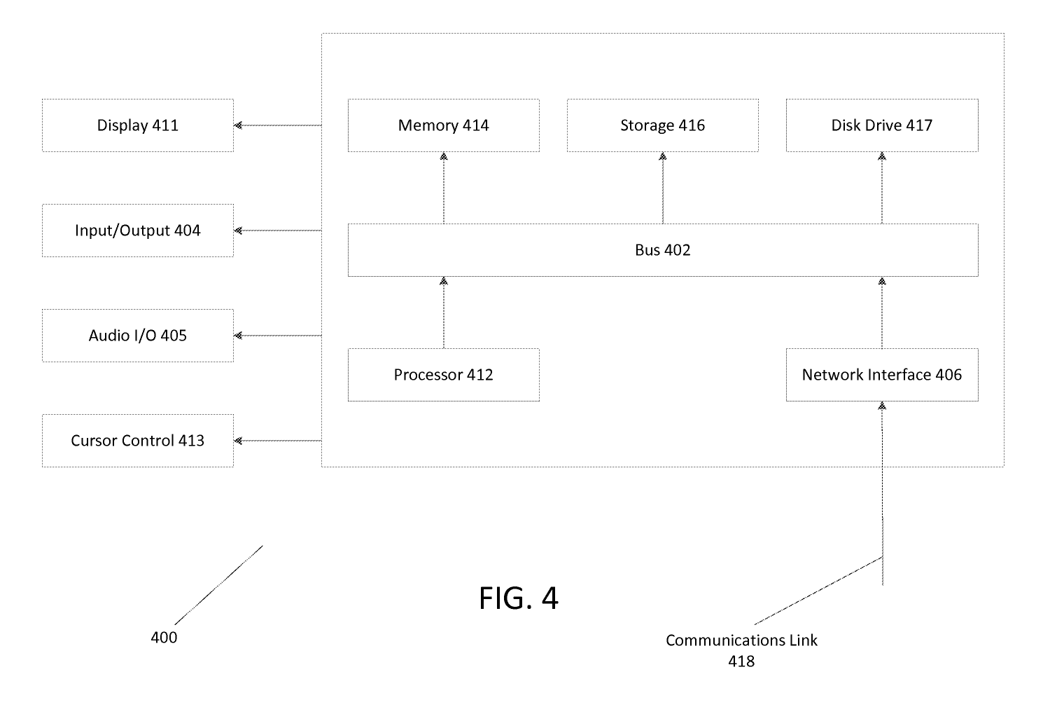

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, Bluetooth device, key FOB, badge, wearable computing device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing information about an account of a user including user preferences; and
one or more processors in communication with the memory and adapted to:
detect a communication device of the user at a shopping location via Near Field Communication (NFC);
determine that the user is in a group at the shopping location by detecting communication devices of other individuals in the group via NFC;
generate one or more group incentives based on preferences of the user and the other individuals in the group; and
communicate the group incentive(s) to at least one individual in the group.

2. The system of claim 1, wherein the communication device of the user is detected at a display at the shopping location.

3. The system of claim 1, wherein the communication device of the user and the communication devices of the other individuals are detected via Bluetooth Low Energy beacons.

4. The system of claim 1, wherein the group incentive(s) are communicated to at least the communication device of the user or one of the communication devices of the other individuals.

5. The system of claim 1, wherein the group incentives are generated by combining and comparing individual preferences of the user and other individuals in the group.

6. The system of claim 1, wherein the group incentives are generated by analyzing group activities experienced together by the group.

7. The system of claim 1, wherein the group incentives are related to activities suitable to be experienced together by the group.

8. The system of claim 1, wherein the group is determined based on a social network or a contact list of the user.

9. A method comprising:
detecting, by a hardware processor, a communication device of a user at a shopping location via Near Field Communication (NFC);
determining, by the processor, that the user is in a group at the shopping location by detecting communication devices of other individuals in the group via NFC;
generating, by the processor, group incentives based on preferences of the user and the other individuals in the group; and
communicating, by the processor, the group incentives to at least one individual in the group.

10. The method of claim 9, wherein the group incentive(s) are communicated to a display at the shopping location.

11. The method of claim 9 further comprising combining and comparing individual preferences of the user and other individuals in the group to generate the group incentives.

12. The method claim 9 further comprising analyzing group activities experienced together by the group to generate the group incentives.

13. The method of claim 9 further comprising determining the group based on a social network or a contact list of the user.

14. The method of claim 9 further comprising determining the group based on interactions among the user and the other individuals detected by a camera or a microphone installed at the shopping location.

15. The method of claim 9 further comprising generating the group incentives based on a number of individuals in the group.

16. The method of claim 9 further comprising formatting the group incentives to be displayed on a display installed at the shopping location at a size and a position based on a position of the group in front of the display.

17. The method of claim 9 further comprising receiving inputs from the group in response to viewing the group incentives.

18. A non-transitory computer-readable medium comprising instructions which, in response to execution by a computer system, cause the computer system to perform a method comprising:
detecting a communication device of a user at a shopping location via Near Field Communication (NFC);
determining that the user is in a group at the shopping location by detecting communication devices of other individuals in the group via NFC;
generating one or more group incentives based on preferences of the user and the other individuals in the group; and
communicating the group incentives to at least one individual in the group.

19. The non-transitory computer-readable medium of claim 18, wherein the method further comprising combining and comparing individual preferences of the user and other individuals in the group to generate the group incentives.

20. The non-transitory computer-readable medium of claim 18, wherein the method further comprising analyzing group activities experienced together by the group to generate the group incentives.
